(19) United States
(12) Patent Application Publication
(10) Pub. No.: US 2017/0372358 A1
(43) Pub. Date: Dec. 28, 2017

(54) BUDGETING FOR CAMPAIGNS ASSOCIATED WITH LOCATIONS

(71) Applicant: Facebook, Inc., Menlo Park, CA (US)

(72) Inventor: Artur Duque de Souza, Sao Paulo (BR)

(21) Appl. No.: 15/192,471

(22) Filed: Jun. 24, 2016

(51) Int. Cl. G06Q 30/02

(52) U.S. Cl. CPC G06Q 30/0249; G06Q 30/0261

(57) ABSTRACT

An online system receives a request from a content provider to run multiple campaigns. Each campaign is for a different physical location. The online system also receives from the content provider a total budget for running the multiple campaigns. The online system determines a campaign budget for each campaign, which is a portion of the total budget allocated to the campaign. For each campaign, the online system determines the campaign budget by determining a geographic region that includes the location associated with the campaign. The online system determines the campaign budget for the campaign based on the total budget and a number of users that were within the geographic region during one or more time periods. The online system executes the campaigns based on the campaign budgets determined for the campaigns.

### BACKGROUND

This invention relates generally to the distribution of content items, and in particular, to allocating a budget among multiple campaigns associated with physical locations.

Occasionally a business entity may want to run campaigns for different locations. For example, an owner of multiple retail locations may want to run a campaign for each of the retail locations to notify users of specific offerings or promotions of each location or particular events occurring at the location. Typically, the budgets for running such campaigns are set evenly across each of the locations. However, the number of customers or potential customers of each location varies. Accordingly, such an even distribution of budget typically results in campaigns having insufficient budget (e.g., more people could have been reached with a bigger budget) or a surplus of budget (e.g., surplus could have been used for other campaigns). As a result, the campaigns are not achieving their full potential, which means less return on investment for the business entity.

### SUMMARY

An online system receives a request from a content provider to run multiple campaigns. Each campaign is for a different physical location. For example, each physical location may be a movie theater, and the content provider requests to run a different campaign for each movie theater. In one embodiment, the locations associated with the campaigns are owned or operated by the same entity. The online system also receives from the content provider a total budget for running the campaigns. The total budget is a maximum amount that can collectively be spent in running the multiple campaigns.

The online system determines a campaign budget for each campaign. A campaign's campaign budget is a portion of the total budget allocated to the campaign. For each campaign, the online system determines the campaign budget by determining a geographic region that includes the physical location associated with the campaign. For example, the geographic region may be a city that includes the location or an area within the city. In one embodiment, the geographic region includes an area within a radius of the location. In some embodiments, the content provider provides the radius to online system for determining the geographic region. In other embodiments, the online system determines the radius for the geographic region. For example, the online system may determine the radius based on a size and/or population of a city that includes the location.

The online system determines the campaign budget for the campaign based on the total budget and a number of users that were within the geographic region during one or more time periods. For example, the campaign budget for the campaign may be determined based on the average number of users that are located within the geographic region on weekends. Hence, the portion of the total budget allocated to each campaign is proportional to the number of users previously present within the corresponding geographic region (e.g., locations with more people nearby will have proportionally larger budgets in order to maximize reach).

The online system executes the campaigns based on the campaign budget determined for each campaign. In some embodiments, the online system executes a campaign by providing a content item associated with the campaigns to users previously located within the geographic region determined for the campaign. In other embodiments, the online system provides the content item to users when they are located within the geographic region.

### BRIEF DESCRIPTION OF THE DRAWINGS

FIG. 1 is a block diagram of a system environment for an online system, in accordance with an embodiment of the disclosure.

FIG. 2 is a block diagram of the online system, in accordance with an embodiment of the disclosure.

FIG. 3 is a flowchart illustrating a process performed by the online system in determining the campaign budgets for campaigns based on a total budget, in accordance with an embodiment of the disclosure.

FIG. 4 is a representative image illustrating the allocation of a total budget to multiple campaigns, in accordance with an embodiment of the disclosure.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

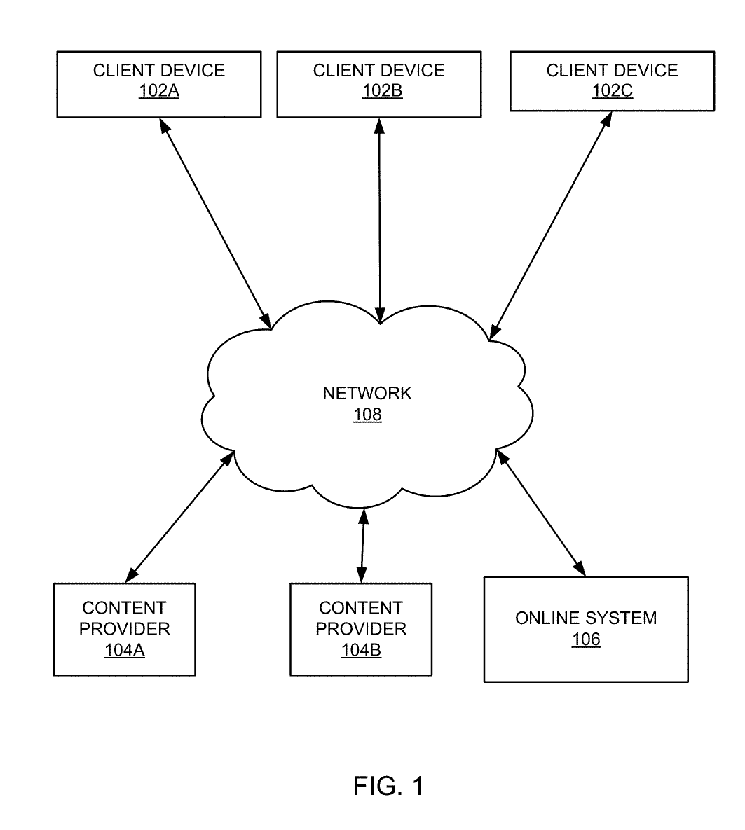

FIG. 1 is a block diagram of a system environment 100 for an online system 106. The system environment 100 shown by FIG. 1 comprises client devices 102A, 102B, and 102C, content providers 104A and 104B, an online system 106, and a network 108. In alternative configurations, different and/or additional components may be included in the system environment 100.

FIG. 1 and other figures use like reference numerals to identify like elements. A letter after a reference numeral, such as “102A,” indicates that the text refers specifically to the element having that particular reference numeral. A reference numeral in the text without a following letter, such as “102,” refers to any or all of the elements in the figures bearing that reference numeral (e.g., 102A, 102B, and 102C).

The network 108 represents communications pathways between the client devices 102, the content providers 104, and the online system 106. The network 108 may comprise any combination of local area and/or wide area networks, using both wired and/or wireless communication systems. In one embodiment, the network 108 uses standard communications technologies and/or protocols. For example, the network 108 includes communication links using technologies such as Ethernet, 802.11, worldwide interoperability for microwave access (WiMAX), 3G, 4G, code division multiple access (CDMA), digital subscriber line (DSL), etc.

A client device 102 is a computing device capable of receiving user inputs as well as sending and/or receiving data via the network 108. The client device 102 may be a mobile device, such as a mobile telephone, a tablet computer, or a personal digital assistant (PDA). Alternatively, the client device 102 may be a conventional computer system, such as a desktop computer.

A user uses a client device 102 to interact with the online system 106. In one embodiment, a client device 102 executes an application allowing a user of the client device 102 to interact with the online system 106. For example, a client device 102 executes a browser application to enable interaction between the client device 102 and the online system 106 via the network 108. In another embodiment, a client device 102 interacts with the online system 106 through an application programming interface (API) running on a native operating system of the client device 102, such as IOS® or ANDROID™.

In one embodiment, a user's client device 102 provides current location information of the user/client device 102 to the online system 106. The location information may be provided by the client device 102 with content (e.g., photos and instant messages) that the user requested to share with the online system 106 and/or with one or more users of the online system 106. For example, the user may generate content (e.g., a photograph) using the client device 102 and request to share content with the online system 106. Along with the content the user may request to share the current location from where the client device 102 generated the content. As another example, the user may request to share his or her current location with the online system 106 so that it can be shared with other users. This is often referred to as a check-in event.

A content provider 104 is a computer system used by an entity to communicate with the online system 106 regarding the online system 106 running campaigns for the entity. Through the campaigns the entity is able to have specific content items distributed to users of the online system 106. In one embodiment, the content items are advertisements.

A content provider 104 may transmit a request to the online system 106 requesting that the online system 106 run multiple campaigns. Each campaign is for a different physical location. A physical location may be, for example, a movie theater, a car dealership, a retail location, a service location, or any other place where a business has a physical presence for providing good and/or services to consumers. For example, the campaign may be to advertise an event occurring at one of the locations, such as the opening of a new movie at a movie theater. The different physical locations for which the content provider 104 requests campaigns be run may be owned or operated by the same entity. For example, the different locations can be the movie theatres of a movie theatre chain.

For each campaign, the content provider 104 provides to the online system 106 information regarding the physical location for which the campaign is to be run, such as a name, address, and/or geographic coordinates of the location. Additionally, for each campaign, the content provider 104 provides to the online system 106 a content item that is to be distributed to users as part of the campaign.

The content provider 104 also provides to the online system 106 a total budget for running the multiple campaigns. The total budget is the maximum amount that can be collectively spent in running the multiple campaigns. The content provider 104 leaves it to the online system 106 to determine how much of the total budget to allocate to each campaign. Based on the information provided by the content provider 104 to the online system 106, the online system 106 executes the multiple campaigns.

The online system 106 is a computer system that shares content with client devices 102. In one embodiment, the online system 106 is a social networking system that enables users of a social network to communicate and share content with each other. In this embodiment, users provide content to the online system 106 via client devices 102 and the online system 106 allows other users to access the content. The users that can access content shared by a user may be restricted based on the types of connections the users have with the sharing user in the social network.

As described above, content providers 104 may request that the online system 106 run multiple campaigns for different physical locations. Content providers 104 requests that campaigns be run in order to have specific content items (e.g., advertisements) distributed to users of the online system 106 that meet certain criteria. When a content provider 104 requests that the online system 106 run multiple campaigns for different locations, the online system 106 identifies a total budget provided by the content provider 104 for the multiple campaigns. The online system 106 allocates a portion of the budget to each campaign by determining a campaign budget for each campaign. The campaign budget for a campaign is determined based on past user presence near the physical location associated with the campaign.

As part of determining a campaign budget for a campaign, the online system 106 determines a geographic region that includes the physical location associated with the campaign. In one embodiment, the geographic region includes an area within a radius of the location. The radius used to determine the area that encompasses the geographic region may be provided by the content provider 104 or determined by the online system 106.

The online system 106 determines a number of users that were located within the geographic region during one or more time periods. The online system 106 determines the campaign budget for the campaign based on the total budget and the number of users that were located within the geographic region during the one or more time periods. The online system 106 executes the campaigns using the campaign budgets determined for the campaigns.

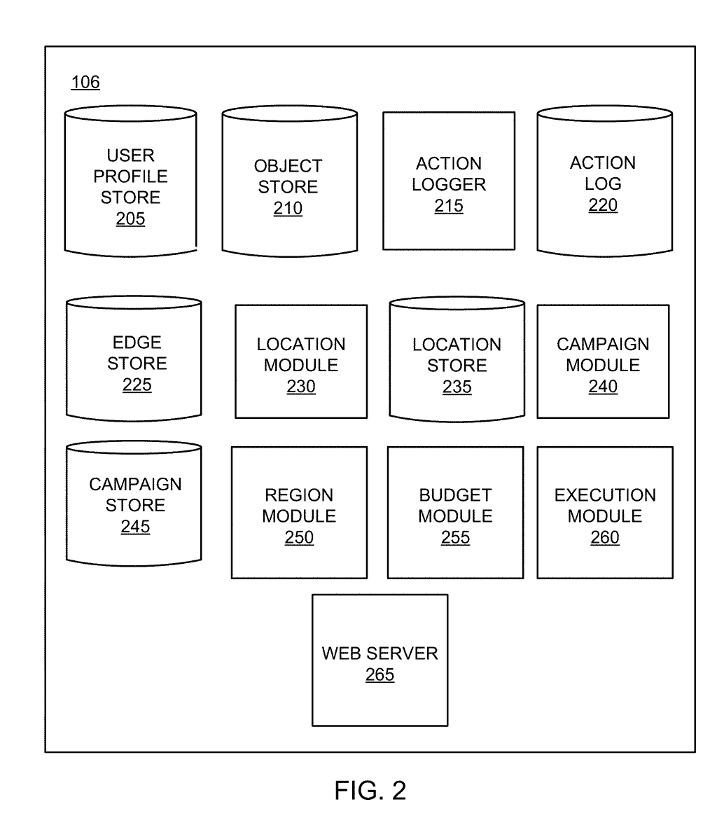

FIG. 2 is an example block diagram of an architecture of the online system 106. The online system 106 shown in FIG. 2 includes a user profile store 205, an object store 210, an action logger 215, an action log 220, an edge store 225, a location module 230, a location store 235, a campaign module 240, a campaign store 245, a region module 250, a budget module 255, an execution module 260, and a web server 265. In other embodiments, the online system 106 may include additional, fewer, or different components for various applications. Conventional components such as network interfaces, security functions, load balancers, failover servers, management and network operations consoles, and the like are not shown so as to not obscure the details of the system architecture.

Each user of the online system 106 is associated with a user profile, which is stored in the user profile store 205. A user profile includes declarative information about the user that was explicitly shared by the user and may also include profile information inferred by the online system 106. In one embodiment, a user profile includes multiple data fields, each describing one or more attributes of the corresponding user of the online system 106. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 106 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 106, user profiles may also be stored for entities such as businesses or organizations. This allows an entity to establish a presence on the online system 106 for connecting and exchanging content with other online system users. The entity may post information about itself, about its products or provide other information to users of the online system 106 using a brand page associated with the entity's user profile. Other users of the online system 106 may connect to the brand page to receive information posted to the brand page or to receive information from the brand page. A user profile associated with the brand page may include information about the entity itself, providing users with background or informational data about the entity.

The object store 210 stores objects that each represents various types of content. Examples of content represented by an object include a page post, a status update, a photograph, a video, a link, a shared content item, a gaming application achievement, a check-in event at a business, a brand page, or any other type of content. Users of the online system 106 may create objects stored by the content store 210, such as status updates, photos tagged by users to be associated with other objects in the online system 106, events, groups or applications. Objects may be created by users by interacting with the online system 106. Objects may also be created by users on their user devices 102 (e.g., taking a photo with a mobile device) and provided to the online system 106 after creation. In some embodiments, objects are received from third-party applications or third-party applications separate from the online system 106. Hence, users of the online system 106 are encouraged to communicate with each other by posting text and content of various types of media through various communication channels. This increases the amount of interaction of users with each other and increases the frequency with which users interact within the online system 106.

The action logger 215 receives communications about user actions internal to and/or external to the online system 106, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the online system 106 to track user actions on the online system 106. Users may interact with various objects on the online system 106, and information describing these interactions is stored in the action log 220. Examples of interactions with objects include: commenting on posts, sharing links, checking-in to locations, accessing content items, and any other interactions. Additionally, the action log 220 may record a user's interactions with content items (e.g., advertisements) provided by the online system 106 to the user, as well as interactions with other applications operating on the online system 106. In some embodiments, data from the action log 220 is used to infer interests or preferences of a user, augmenting the interests included in the user's user profile and allowing a more complete understanding of user preferences.

The action log 220 may also store user actions taken on an external website, and communicated to the online system 106. For example, an e-commerce website that primarily sells sporting equipment at bargain prices may recognize a user of the online system 106 through a plug-in enabling the e-commerce website to identify the user of the online system 106. Because users of the online system 106 are uniquely identifiable, e-commerce websites, such as this sporting equipment retailer, may communicate information about a user's actions outside of the online system 106 to the online system 106 for association with the user. Hence, the action log 220 may record information about actions users perform on a webpage viewing histories, advertisements that were engaged, purchases made, and other patterns from shopping and buying.

In one embodiment, an edge store 225 stores information describing connections between users and other objects on the online system 106 as edges. The users and objects can be represented as nodes connected by edges to form a social graph. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 106, such as expressing interest in a page of the online system 106, sharing a link with other users of the online system 106, and commenting on posts made by other users of the online system 106.

The edge store 225 also stores information about edges, such as affinity scores for objects, interests, and other users. Affinity scores, or “affinities,” may be computed by the online system 106 over time to approximate a user's affinity for an object, interest, and other users in the online system 106 based on the actions performed by the user. A user's affinity may be computed by the online system 106 over time to approximate a user's affinity for an object, interest, and other users in the online system 106 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The location module 230 tracks geographic locations of users of the online system 106. The online system 106 identifies information received from client devices 102 that indicates the current geographic locations of users and updates the location store 235 based on the information. Users share their location with the online system 106 so that it can be shared with one or more other users. A user's geographic location may be provided as a check-in or provided along with content (e.g., with a photo, an instant message, or a post). A user's geographic location may also be shared by other users. For example, when a user shares his current location, the user may also indicate other users that are with him.

In one embodiment, the location module 230 monitors the object store 210 and/or the action log 220 to determine when information is received by the online system 106 that indicates a user's geographic location. When the online system 106 receives information that indicates a geographic location of one or more users, the location module 230 identifies timing information (e.g., time and date) associated with the geographic location. The timing information may be for example, when the geographic location information was transmitted by a client device 102 to the online system 106, when the online system 106 received the geographic location information, or when content was generated that included geographic location.

The location module 230 stores the geographic location in the location store 235 along with the timing information and an indication of the one or more users that were at the location. Hence, the location store 235 stores information that indicates the geographic locations of users at different times. In one embodiment, a geographic location stored in location store 235 is stored as a pair of latitude and longitude. In another embodiment, the geographic location is stored as a street address (e.g. street number, street name, city, and zip code).

The campaign module 240 processes requests by content providers 104 for the execution of campaigns. When a content provider 104 requests that multiple marketing campaigns be run for different physical locations, the campaign module 240 provides the content provider 104 with one or more interfaces through which the entity operating the content provider 104 can provide information for running the campaigns. Through the interface the entity provides a total budget for running the multiple campaigns. The total budget may be for the life of the campaigns or for a shorter time period (e.g., a daily total budget or a weekly total budget).

For each of the multiple campaigns, the entity indicates through the interface the physical location for which the campaign is to be run (the location associated with the campaign). The entity indicates the physical location by providing a name, address, and/or geographic coordinates of the location. In one embodiment, each campaign is associated with a different physical location. In another embodiment, two or more of the campaigns may be associated with the same location. For each campaign, the entity also indicates a content item that is to be provided to users as part of the campaign. In one embodiment, the content item is an advertisement. The content item may include, for example, text, images, audio, video, or any other suitable data presentable to a user. The content item may be specific for the location associated with the campaign and include information related to the location. For example, if the location is a retail location, the content item may promote specific items that are unique to the location.

Additionally, for each campaign the entity indicates one or more targeting criteria and a bid amount. Targeting criteria of a campaign indicates conditions that need to be met for the content item of the campaign to be presented to a user. The criteria may relate to which users the content item should be presented and/or particular actions taken by a user that should trigger the presentation of the content item. For example, the targeting criteria may indicate that the content item be presented to users that were previously near the physical location of the campaign, such as users near the location in the past 72 hours or users that were previously near the location on weekend evenings. As another example, the targeting criteria may indicate that the content item be presented to users when they are currently near the location. In one embodiment, the bid amount is associated with a monetary compensation provided by the entity to the online system 106 if content item is presented to a user, if the content item receives a user interaction, or based on any other suitable condition. When the one or more conditions of the bid amount are satisfied, the bid amount or an amount related to the bid amount (e.g., the next highest bid amount in the auction) is deducted from the campaign's budget.

The campaign module 240 stores the information received for the campaigns through the one or more interfaces in the campaign store 245. The information stored in the campaign store 245 is used by the execution module 260 to execute the campaigns.

The region module 250 determines geographic regions for campaigns. As described below with reference to the budget module 255, for the budget module 255 to divide up a total budget among multiple campaigns, the budget module 255 uses a geographic region for each campaign to determine the number of users that have previously been near the location of each campaign. The region module 250 determines the geographic region for each of the multiple campaigns. The geographic region determined by the region module 250 for a campaign includes the physical location associated with the campaign.

In one embodiment, the region module 250 determines the geographic region of a campaign to be an area within a radius of the location associated with the campaign. In one embodiment, the radius is set by a system administrator or by the content provider 104 that requested the campaign be run. In another embodiment, the region module 250 determines the radius for the geographic region based on the population density of the city that includes the location. In this embodiment, the region module 250 uses the population density to select a radius that results in the geographic region having approximately a specific number of people. In one embodiment, the specific number of people is set by a system administrator. As an example, for a campaign associated with a location in a densely populated city, the radius would be greater than the radius used for a campaign associated with a location in a rural city.

In one embodiment, the region module 250 determines the radius of the geographic region based on the size of the city that includes the location. For example, the region module 250 may determine the radius based on the total land area of the city. Although, specific statistics of a city are described herein as being used to determine the radius/geographic region, in other embodiments statistics of larger or smaller areas may be used, such as statistics of counties, states, provinces, district, boroughs, etc.

In one embodiment, the region module 250 determines the radius for the geographic region based on location information of users of the online system 106. The region module 250 uses the information stored in the location store 235 to select a radius that results in the geographic region having approximately a certain number of users. Determining an estimated number of users within an area is further described in U.S. patent application Ser. No. 14/563,858, filed on Dec. 8, 2014, which is hereby incorporated by reference in its entirety.

In one embodiment, the region module 250 determines the geographic region of the campaign to be the city that includes the associated location or a larger area, such as the county that includes the location. In one embodiment, the content provider 104 that requested that the campaign be run specifies the geographic region.

The region module 250 stores information regarding the determined geographic region in the campaign store 245 in association with the campaign for which the region was determined.

The budget module 255 determines campaign budgets for campaigns. When a total budget is received for running multiple campaigns, the budget module 255 allocates a portion of the total budget to each campaign. The portion of the total budget allocated to a campaign is referred to as the campaign budget of the campaign. To determine the campaign budgets for a campaign, the budget module 255 determines from the campaign store 245 the geographic region determined for the campaign by the region module 250. The budget module 255 determines a presence value for the campaign based on a number of users located within the geographic region during one or more time periods. The number of users within the geographic region during the one or more time periods is determined by the budget module 255 based on the information stored in the location store 235.

In one embodiment, the content provider 104 that requested the campaign be run indicates the time periods for determining the presence value and how the presence value should be calculated based on the number of users. For example, based on instructions received from the content provider 104, the budget module 255 may determine the presence value by averaging the number of users located within geographic region each weekend for the past three months. As another example, the budget module 255 may determine the presence value to be the total number of users located within the geographic region during the past week.

The budget module 255 determines the campaign budget for the campaign based on the total budget and the determined presence value. In one embodiment, the budget module 255 determines the campaign budget by summing the presence values determined for the multiple campaigns that are being allocated a portion of the total budget. The budget module 255 divides the presence value of the campaign by the sum. The budget module 255 then multiplies the quotient by the total budget to obtain the campaign budget for the campaign. The budget module 255 stores the determined campaign budget in the campaign store 245 in association with campaign.

The execution module 260 executes the campaigns stored in the campaign store 245. The execution module 260 provides content items to users when targeting criteria of the respective campaigns is satisfied. For example, the targeting criteria of a campaign may indicate that a content item be provided to users that were near the associated location in the past 72 hours. If an opportunity arises to provide a content item to a user and the execution module 260 determines based on the information stored in the location store 235 that the user was within the geographic region of the campaign within the past 72 hours, the execution module 260 provides the content item of the campaign to the client device 102 of the user. Hence, in this example the same geographic region used to determine the budget for the campaign is also used to determine whether to provide the content item to a user. The content item may be provided with other content (e.g., with content requested by the user). In a similar example, the targeting criteria may indicate that the content item be provided to users when they are near the associated location. If an opportunity arises to provide a content item to a user and the execution module 260 determines based on the information stored in the location store 235 that the user is currently within the geographic region of the campaign, the execution module 260 provides the content item to the client device 102 of the user.

In one embodiment, when an opportunity arises to present a content item to a user, there may be a limit on the number of content items that can be provided to the user's client device 102 (e.g., limited number of slots). However, the number of content items eligible to be provided may exceed the limit. In response the execution module 260 selects each content item to provide based on the bid amount associated with the content item and/or the likelihood that the user will interact with the content item. The likelihood may be determined by the execution module 260, for example, based on at least one of: previous actions of the user, information from the user's profile, and actions by other users (e.g., interactions by other users with the content item).

In one embodiment, when a condition of a campaign's bid amount is satisfied, the execution module 260 deducts the bid amount from the campaign budget of the campaign. The execution module 260 stores information in the campaign store 245 indicating the new budget of the campaign. The condition of the bid amount may be satisfied, for example, when the content item of the campaign is presented to a user or when a user interacts with the content item. In one embodiment, once a campaign's campaign budget is exhausted, the execution module 260 stops running the campaign until the campaign gets a new budget.

In one embodiment, the execution module 260 generates metrics for campaigns based on the information described above that the execution module 260 tracks for content items (e.g., when content items are provided to users and when users interact with content items). The execution module 260 provides a campaign's metrics to the respective content provider 104. A metrics provided to a content provider 104 for a campaign may indicate, for example, the total number of users to which the associated content item was presented. Another metric may indicate out of the total number of times the content item was presented how many times users interacted with content item.

The execution module 260 may also obtain from the content provider 104 or from public sources sales information to determine metrics that indicate the amount spent on the campaign per sale. For example, assume the location for which a campaign is run is a movie theatre and that the execution module 260 obtains information indicating the number of ticket sales at the movie theatre the past weekend. Based on the information in the campaign store 245 for the campaign, the execution module 260 determines the amount of budget spent on the campaign the past weekend. Based on the number of ticket sales and the amount of budget spent, the execution module 260 determines a cost per ticket sale.

The web server 265 links the online system 106 via the network 108 to the one or more client devices 102. The web server 265 serves web pages, as well as other web-related content, such as JAVA®, FLASH®, XML and so forth. The web server 265 may receive and route messages between the online system 106 and the client devices 102, for example, instant messages, queued messages (e.g., email), text messages, short message service (SMS) messages, or messages sent using any other suitable messaging technique. A user may send a request to the web server 265 to upload information (e.g., images or videos) that are stored in the object store 210. Additionally, the web server 265 may provide application programming interface (API) functionality to send data directly to native client device operating systems, such as IOS®, ANDROID™, WEBOS® or RIM®.

### Budgeting Process

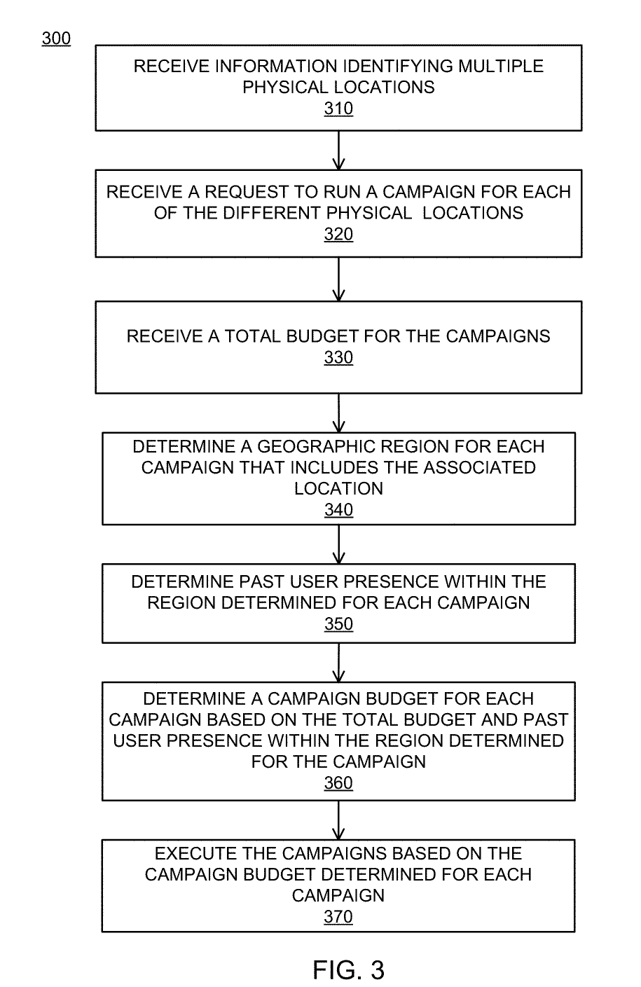

FIG. 3 is a flowchart illustrating a process 300 performed by the online system 106 in determining the campaign budgets for campaigns based on a total budget. Those of skill in the art will recognize that other embodiments can perform the steps of FIG. 3 in different orders. Moreover, other embodiments can include different and/or additional steps than the ones described herein.

The online system 106 receives 310 from a content provider 104 information identifying multiple physical locations. For example, each physical location may be a retail location or some other type of business location. The online system 106 also receives 320 from the content provider 104 a request to run a different campaign for each of the physical locations. Additionally, the online system 106 receives 330 from the content provider 104 a total budget for running the multiple campaigns.

To determine how much of the total budget to allocate to each campaign, for each campaign, the online system 106 determines 340 a geographic region that includes the location associated with the campaign. The online system 106 determines 350 past user presence within the region determined for the campaign. The online system 106 determines 360 a campaign budget for the campaign based on the total budget and the past user presence within the geographic region. The online system 106 executes 370 the multiple campaigns based on the campaign budgets determined for the campaigns.

### EXAMPLES

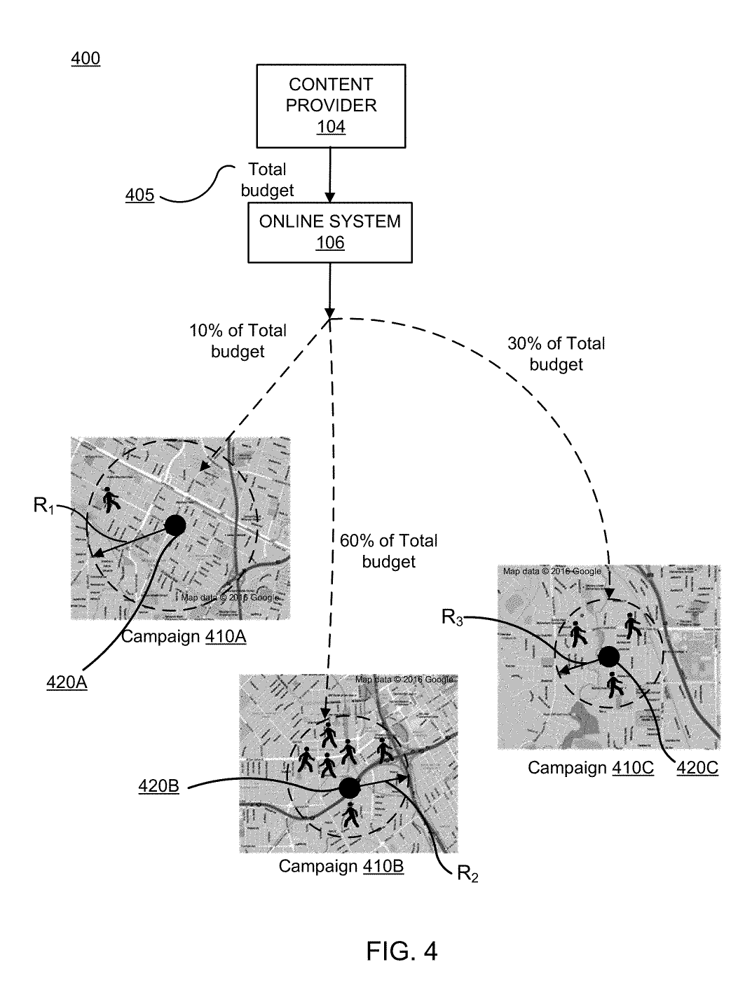

FIG. 4 is a representative image 400 illustrating the allocation of a total budget 405 to multiple campaigns. As can be seen in FIG. 4, a content provider 104 provides a total budget 405 to the online system 106 for running three campaigns, campaign 410A, campaign 410B, and campaign 410C. Each of the campaigns 410 is for a different physical location. Campaign 410A is for location 420A, campaign 410B is for location 420B, and campaign 410C is for location 420C.

The online system 106 determines a geographic region for each campaign 410 that includes the associated physical location 420. In this example, the geographic region determined for each campaign 410 is a different size. The geographic region of campaign 410A has a radius R₁, the geographic region of campaign 410A has a radius R₂, and the geographic region of campaign 410C has a radius R₃.

For each campaign 410 the online system 106 determines a number of users previously located within the respective geographic region during a time period. In this example, the online system 106 determines that the geographic region of campaign 410A included one user, that the geographic region of campaign 410B included six users, and that the geographic region of campaign 410C included three users. Hence, the three geographic regions included a total of ten users. Since the region of campaign 410A only included one of the ten users, 10% of the total budget 405 is allocated to campaign 410A. Campaign 410B is allocated 60% of the total because 405 because the respective region included six of the ten users and campaign 410C is allocated 30% of the budget because the respective region included three of the ten users.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computer system from a content provider, information identifying a plurality of physical locations;
receiving, by the computer system from the content provider, a total budget for a plurality of campaigns, each of the plurality of campaigns associated with a different physical location from the plurality of physical locations;
receiving, by the computer system for each of the plurality of campaigns, a content item to be displayed to users as part of the campaign, the content item including information related to the physical location associated with the campaign;
for each of the plurality of campaigns:
determining, by the computer system, a geographic region that includes the physical location associated with the campaign;
determining, by the computer system, a campaign budget for the campaign based on the total budget and user presence within the geographic region, the campaign budget a portion of the total budget; and
executing, by the computer system, the campaign based on the determined campaign budget.

2. The method of claim 1, wherein determining the geographic region comprises:
determining a radius for the campaign; and
determining the geographic region to include area within the radius of the physical location.

3. The method of claim 2, wherein the radius is received from the content provider.

4. The method of claim 2, wherein the radius is determined based on a population of an additional geographic region that includes the physical location associated with the campaign.

5. The method of claim 1, wherein determining the campaign budget for the campaign comprises:
determining the campaign budget based on the total budget and a number of users located within the geographic region during one or more time periods.

6. The method of claim 1, wherein determining the campaign budget for the campaign comprises:
determining a measure indicating a number of users located within the geographic region during one or more time periods;
determining a sum of the measures determined for the plurality of campaigns; and
determining the campaign budget for the campaign based on the determined measure, the sum, and the total budget.

7. The method of claim 6, wherein the measure is an average number of users located within the geographic region during the one or more time periods.

8. The method of claim 6, wherein the measure is a total number of users located within the geographic region during the one or more time periods.

9. The method of claim 1, wherein a sum of the campaign budgets determined for the plurality of campaigns does not exceed the total budget.

10. The method of claim 1, wherein executing the campaign comprises:
providing the content item received for the campaign to a plurality of users previously located within the geographic region.

11. The method of claim 1, wherein executing the campaign comprises:
providing the content item received for the campaign to a user responsive to the user being located within the geographic region.

12. A computer program product comprising a non-transitory computer-readable storage medium containing computer program code which when executed by one or more processors causes the one or more processors to perform operations comprising:
receiving from a content provider information identifying a plurality of physical locations;
receiving from the content provider a total budget for a plurality of campaigns, each of the plurality of campaigns associated with a different physical location from the plurality of physical locations;
receiving, for each of the plurality of campaigns, a content item to be displayed to users as part of the campaign, the content item including information related to the physical location associated with the campaign;
for each of the plurality of campaigns:
determining a geographic region that includes the physical location associated with the campaign;
determining a campaign budget for the campaign based on the total budget and user presence within the geographic region, the campaign budget a portion of the total budget; and
executing the campaign based on the determined campaign budget.

13. The computer program product of claim 12, wherein determining the geographic region comprises:
determining a radius for the campaign; and
determining the geographic region to include area within the radius of the physical location.

14. The computer program product of claim 13, wherein the radius is determined based on a population of an additional geographic region that includes the physical location associated with the campaign.

15. The computer program product of claim 12, wherein determining the campaign budget for the campaign comprises:
determining the campaign budget based on the total budget and a number of users located within the geographic region during one or more time periods.

16. The computer program product of claim 12, wherein determining the campaign budget for the campaign comprises:
determining a measure indicating a number of users located within the geographic region during one or more time periods;
determining a sum of the measures determined for the plurality of campaigns; and
determining the campaign budget for the campaign based on the determined measure, the sum, and the total budget.

17. The computer program product of claim 16, wherein the measure is an average number of users located within the geographic region during the one or more time periods.

18. The computer program product of claim 16, wherein the measure is a total number of users located within the geographic region during the one or more time periods.

19. The computer program product of claim 12, wherein executing the campaign comprises:
providing the content item received for the campaign to a plurality of users previously located within the geographic region.

20. The computer program product of claim 12, wherein executing the campaign comprises:
providing the content item received for the campaign to a user responsive to the user being located within the geographic region.
